(19) United States
(12) Patent Application Publication
(10) Pub. No.: US 2023/0226518 A1
(43) Pub. Date: Jul. 20, 2023

(54) MODIFIED CLAY SORBENTS WITH MULTIFUNCTIONAL QUATERNARY AMMONIUM COMPOUNDS AND MONO-QUATERANRY AMMONIUM COMPOUNDS AND METHODS OF SORBING PER- AND POLYFLUOROALKYL SUBSTANCES (PFAS) FROM CONTAMINATED SAMPLES WITH THE MODIFIED CLAY SORBENTS

(71) Applicant: Specialty Minerals (Michigan) Inc., Bingham Farms, MI (US)

(72) Inventor: Michael Donovan, Hoffman Estates, IL (US)

(21) Appl. No.: 17/925,282

(22) PCT Filed: May 21, 2021
(86) PCT No.: PCT/US2021/033592

§ 371 Date: Nov. 14, 2022

Related U.S. Application Data
(60) Provisional application No. 63/029,261, filed on May 22, 2020.

(51) Int. Cl. B01J 20/22; B01J 20/12; C02F 1/28; B09C 1/08; B09C 1/00

(52) U.S. Cl. CPC B01J 20/22; B01J 20/12; C02F 1/288; B09C 1/08; B09C 1/002; C02F 1/285; C02F 1/281; C02F 2101/36

(57) ABSTRACT

A method of sorbing a PFAS compound from a contaminated sample can include admixing a modified clay sorbent with the sample. The modified clay can include a clay intercalated with a blend of mono-quatemary amine compound and multifunctional-quatemary amine compound having a functionality of 3 or more.

### CROSS-REFERENCE TO RELATED APPLICATION

The benefit of priority to U.S. Provisional Patent Application No. 63/029,261 filed May 22, 2020 is hereby claimed and the disclosure is incorporated herein by reference in its entirety.

### BACKGROUND

### Field of the Disclosure

The disclosure relates to methods of sorbing PFAS compounds, and in particular sorbing PFAS compounds using a clay modified with one or more multi-functional quaternary amine compounds having a functionality of three or more.

### Brief Description of Related Technology

Perfluorinated compounds (PFCs) have wide application and as a result have become a global concern in contamination of water environments. Per- and polyfluoroalkyl substances (conventionally referred to collectively as PFAS) are a group of man-made chemicals that includes PFOA, PFOS, GenX, and many other chemicals. PFAS have been manufactured and used in a variety of industries, including in the United States since the 1940s. Perfluorooctane sulfonate (PFOS) is one of the typical PFCs and has been used in many industries as surfactants, fire retardants, lubricants, and polymer additives. Perfluorooctanoic acid (PFOA) and PFOS have been the most extensively produced and studied of these chemicals. PFCs can accumulate over time in the human body and many do not naturally break down. PFAS exposure has been demonstrated to be detrimental to human health. PFC removal from waste water sources is critical to the prevention of contamination of natural waterways. Since PFCs are generally very stable, they are difficult to decompose in ambient environments using some conventional technologies including bio-logical degradation, oxidation and reduction. Sorption has been used as an alternative method to effectively remove PFCs from wastewater, soil, and other contaminated sources with conventional sorbents including activated carbon, resin, and biosorbents.

### SUMMARY

The technical information set out below may in some respects go beyond the disclosure of the invention, which is defined exclusively by the appended claims. The additional technical information is provided to place the actual invention in a broader technical context and to illustrate possible related technical developments. Such additional technical information which does not fall within the scope of the appended claims, is not part of the invention.

There is a need for improved methods of sorbing PFAS compounds from soils, wastewaters and other contaminated sources.

A modified clay sorbent in accordance with the disclosure can include a clay intercalated with one or more multifunctional-quatemary amine compounds having a functionality of 3 or more and one or more mono-quaternary amine compounds. In embodiments, the one or more multifunctional-quatemary amine compounds are present in a mole percent of about 25 mol % to about 95 mol % based on total moles of quatemary amine compounds present in the modified clay sorbent.

A modified clay sorbent in accordance with the disclosure can include a first modified clay comprising a clay intercalated with the one or more mono-quaternary amine compounds; and a second modified clay comprising a clay intercalated with the one or more multifunctional-quatemary amine compounds having a functionality of 3 or more. In embodiments, the second modified clay can be present in the modified clay sorbent in an amount such that the one or more multifunctional-quaternary amine compounds are present in an amount of about 25 mol % to about 95 mol % based on total moles of quatemary amine compounds present in the modified clay sorbent.

A method of sorbing PFAS compounds from a contaminated sample in accordance with the disclosure can include admixing a modified clay sorbent with the sample, wherein the modified clay sorbent comprises a clay intercalated with one or more multifunctional quaternary amine compounds having a functionality of 3 or more.

A method of sorbing PFAS compounds from a contaminated sample in accordance with the disclosure can include admixing a modified clay sorbent with the sample, wherein the modified clay sorbent comprises a clay intercalated with a one or more mono-quaternary amine compounds and one or more multifunctional-quatemary amine compounds having a functionality of 3 or more. In embodiments, the one or more multifunctional-quatemary amine compounds are present in an amount of about 25 mol % to about 95 mol % based on the total mole percent of the quatemary amine compounds in the modified clay sorbent.

A method of sorbing PFAS compounds from a contaminated sample can include admixing a modified clay sorbent with the sample, wherein the modified clay sorbent comprises a first modified clay comprising a clay intercalated with a one or more mono-quatemary amine compounds and a second modified clay comprising a clay intercalated with one or more multifunctional-quatemary amine compounds having a functionality of 3 or more. In embodiments, a ratio of an amount of the first modified clay to the amount of the second modified clay is selected such that the one or more multifunctional-quatemary amine compounds are present in an amount of about 25 mol % to about 95 mol % based on the total mole percent of the quatemary amine compounds admixed with the sample.

In any of the modified clay sorbets or methods herein the multi-functional quatemary amine compound can be a trifunctional-quatemary amine compound (also referred to herein as “triquat”).

### BRIEF DESCRIPTION OF THE DRAWINGS

FIG. 1 is a graph showing the percent removal of various PFAS as a function of trifunctional quaternary amine compound mole percent; and

FIG. 2 is a bar graph showing percent removal of various PFAS as a function of trifunctional quaternary amine compound mole percent.

### DETAILED DESCRIPTION

The technical information set out below may in some respects go beyond the disclosure of the invention, which is defined exclusively by the appended claims. The additional technical information is provided to place the actual invention in a broader technical context and to illustrate possible related technical developments. Such additional technical information which does not fall within the scope of the appended claims, is not part of the invention.

Modified clay sorbents are disclosed herein for sorbing PFAS compounds. The modified clay sorbents can include a clay component modified with a blend of one or more mono-quatemary amine compounds and one or more multifunctional-quatemary amine compounds having a functionality of 3 or more. The modified clay sorbent can be modified with one or more multifunctional-quatemary amine compounds having a functionality of 3 or more. A method of sorbing PFAS compounds from a contaminated sample can include contacting or otherwise exposing the sample to one or more modified clay sorbents. In such methods, the modified clay sorbent can be modified with a multifunctional-quaternary amine compound having a functionality of 3 or more or with a blend of a mono-quatemary amine compound and a multifunctional-quatemary amine compound having a functionality of 3 or more. In any of the sorbents herein, the clay can be modified with more than one mono-quatemary amine compound and/or more than one multifunctional-quatemary amine compound. In any of the sorbents or methods herein, the multifunctional-quaternary amine compound can be a trifunctional-quaternary amine compound (triquat).

Modified clay sorbents of the disclosure can be made by reacting a clay with one or more quatemary amine compounds or blend of quaternary amine compounds. The reaction is done under conditions to intercalate the clay with the one or more quaternary amine compounds. The modified clay sorbent can include a clay intercalated with one or more multifunctional-quatemary amine compounds having a functionality of 3 or more. The clay can be further intercalated with one or more mono-quaternary amine compounds and/or one or more diquatemary amine compounds. A modified clay sorbent blend can include a blend of a first clay intercalated with one or more mono-quaternary amine compounds and a second clay intercalated with one or more multifunctional-quatemary amine compound with a functionality of 3 or more. The one or more multifunctional-quatemary amine compounds in any of the sorbents of the disclosure can be or can include a triquat.

Modification of a clay to intercalate a quaternary amine compound can be done according to any know methods in the art, including wet processing methods and dry, extrusion based methods. In embodiments, the reaction can include mixing approximately 1 molecule of quat per exchangeable cation in the clay. For example, the quatemary amine compound or compound blends can be mixed with water and then clay can be added to the mixture to react the clay with the multi-functional quaternary amine compounds. The mixture can then be dried and ground into granules or a powder for use.

The sorbents of the disclosure should be understood as agents that can bind, immobilize, or otherwise associate with a contaminant via sorption of the contaminant to the modified clay sorbent. “Sorption” as referred to herein should be understood to include adsorption of the contaminant to the surface of the sorbent and/or absorption of the contaminant into all or part of the sorbent.

In any of the sorbents disclosed herein, the clay can be phyllosilicates, such as smectite clay minerals, e.g., montmorillonite, particularly sodium montmorillonite; magnesium montmorillonite and/or calcium montmorillonite; attapulgite, heat treated attapulgite, nontronite; beidellite; volkonskoite; hectorite; saponite; sauconite; sobockite; stevensite; svinfordite; vermiculite; palygorskite; kaolinite; sepiolite and the like. Other useful layered materials include micaceous minerals, such as illite, clintonite, muscovite, biotite and the like and mixed layered illite/smectite minerals, such as rectorite, tarosovite, ledikite and admixtures of illites with the clay minerals named above.

The swellable layered materials can be phyllosilicates of the 2:1 type having a negative charge on the layers ranging from about 0.15 to about 0.9 charges per formula unit and a commensurate number of exchangeable metal cations in the interlayer spaces. Most preferred layered materials are smectite clay minerals such as montmorillonite, nontronite, beidellite, volkonskoite, hectorite, saponite, sauconite, sobockite, stevensite, and svinfordite.

Modified Clay Sorbent with Mono-Quaternary and Multifunctional-Quaternary Blend and Modified Clay Sorbent Blends

The modified clay sorbents can include a clay intercalated with a blend of one or more mono-quatemary amine compounds and more or more multifunctional-quaternary amine compounds having a functionality of 3 or more. A modified clay sorbent can also or alternatively be provided having a first modified clay with a clay intercalated with one or more mono-quatemary amine compounds and a second modified clay with a clay intercalated with one or more multifunctional-quaternary amine compounds having a functionality of 3 or more. The modified clay sorbent having the first and second modified clays can be provided as a single blended composition or as separate components to be added to a contaminated source. It is further contemplated herein that the modified clay sorbent having the first and second modified clays can include a further clay intercalated with a blend of one or more mono-quatemary amine compounds and one or more multifunctional-quatemary amine compounds having a functionality of 3 or more. Modified clay sorbents in accordance with the disclosure can include any suitable number of modified clay components, including, for example, multiple clay components intercalated with blends of mono-quatemary and multifunctional-quaternary amine compounds having a functionality of 3 or more at different mono- to multifunctional-quatemary amine compound ratios. Further, modified clay sorbents with the disclosure can include unmodified clay. The modified clay sorbents of the disclosure can be provided with all or some of the components pre-blended for single addition to a contaminated source for PFAS removal. Alternatively, one or more of the components can be provided for separate addition to the contaminated source. In embodiments, the modified clay sorbent, whether a single component blend, a single clay component modified with a blend of quaternary amine compounds, or a separate components, can consist of one or more multifunctional-quatemary amine compounds having a functionality of 3 or more and one or more mono-quatemary amine compounds. That is, the sorbent can include only the multifunctional and mono-functional quaternary amine compounds.

In embodiments, the modified clay sorbents can include about 5 mol % to about 95 mol %, or about 25 mol % to about 95 mol % of multifunctional-quatemary amine compound having a functionality of 3 or more based on the total moles of quatemary amine compound in the modified clay sorbent. The modified clay sorbents of the disclosure be useful in removal of PFAS compounds, and particularly removal of long-chain PFAS compounds, short-chain PFAS compounds, and current commonly regulated PFAS compounds. It has been found that modified clay sorbents having 20 mol % to about 80 mol % of the multifunctional-quatemary amine compound having a functionality of 3 or more based on the total moles of quatemary amine compound in the modified clay sorbent had improved removal of short chain compounds as compared to mole percentages outside this range. For example, a modified clay sorbent targeted for short chain PFAS removal can have about 20 mol % to about 80 mol % triquat based on the total moles of quaternary amine compound in the modified clay sorbent. Such a clay sorbent can include as the remainder amount of quaternary amine compound, mono-quatemary amine compound. It has been found that modified clay sorbents having 20 mol % or greater of the multifunctional quatemary amine compounds having a functionality of 3 or more based on the total moles of quatemary amine compound in the modified clay sorbent demonstrate improved carboxylate-PFAS removal as compared to amounts below 20 mol %. For example, a modified clay sorbent targeted for carboxylate-PFAS removal can include at least 20 mol % of a triquat. For long chain PFAS removal, it was found that amounts in excess of 60 mol % of the multifunctional quatemary amine compound having a functionality of 3 or more based on the total moles of quatemary amine compound in the modified clay sorbent demonstrated improved sorption. For example, a modified clay sorbent targeted for long chain PFAS removal can have greater than 60 mol % of a triquat. Selection of an amount of moles of the multifunctional quatemary amine compound having a functionality of 3 or more can be tailored to have targeted removal of desired classes of PFAS compounds. In embodiments in which the modified clay sorbent is provided as separate components, the components can added to the contaminated sample sequentially or simultaneously. For example, the components can be added such that the amount of multifunctional-quatemary amine compound having a functionality of 3 or more is about 25 mol % to about 95 mol % based on the total moles of quaternary amine compound added to the contaminated sample. As used herein “long-chain PFAS compounds” refers to PFAS compounds having 6 or more carbons. As used herein “short-chain PFAS compounds” refers to PFAS compounds having less than 6 carbons. As used herein “regulated PFAS compounds” includes perfluorononanoic acid (PFNA), perfluorooctanoic acid (PFOA), perfluorooctane sulfonic acid (PFOS), perfluorohexane sulfonic acid (PFHxS), and perfluoroheptanoic acid (PFHpA).

In embodiments, the modified clay sorbent includes one or more multifunctional-quatemary amine compound in a molar amount based on the total amount of quaternary amine compound in the sorbent of about 5 mol % to 20 mol %, 25 mol % to about 95 mol %, about 30 mol % to about 70 mol %, about 25 mol % to about 50 mol %, about 30 mol % to about 50 mol %, about 25 mol % to about 40 mol %, about 25 mol % to about 30 mol %. Other suitable amounts of multifunctional-quatemary amine compound include about 5, 10, 15, 20, 25, 26, 27, 28, 29, 30, 31, 32, 33, 34, 35, 36, 37, 38, 39, 40, 41, 42, 43, 44, 45, 46, 47, 48, 49, 50, 52, 54, 56, 58, 60, 62, 64, 66, 68, 70, 72, 74, 76, 78, 80, 82, 84, 86, 88, 90, 92, 94, and 95 mol %. In applications in which the presence of extractables from a sorbent is disadvantageous, it can be useful to limit the amount of multifunctional-quaternary amine compounds having a functionality of 3 or more to an upper limit of about 50 mol %.

The modified clay sorbents or modified clay sorbent blends of the disclosure were advantageously found to have high PFAS removal capacity and efficiency. This improvement in PFAS removal capacity and efficiency can allow for less sorbent to be utilized for removal of the same or substantially the same percentage of PFAS from a contaminated source, as compared to a conventional clay sorbent using mono-quatemary amine compound. Further, the improved removal efficiency can allow for high flow rates of material to be pumped through the modified clay sorbents and modified clay sorbent blends of the disclosure, improving overall plant efficiency.

Without intending to be bound by theory, it is believed that the combination of the mono-quatemary amine compound and the multifunctional-quatemary amine compounds having a functionality of 3 or more introduces an electrostatic force between the clay platelets that can allow the PFAS better access to the interior of the sorbent material. This, along with the hydrophobicity, provided by the quatemary amine compounds and particularly the mono-quatemary amine compound is believed to result in the improvement in both sorbent capacity and efficiency.

It has further been found advantageous to intercalate the clay with the quatemary amine compounds to at least about 50% of the cationic exchange capacity of the clay. For example, the clay can be intercalated to about 50% to about 120%, about 80% to about 100%, about 60% to about 90%, or about 75% to about 115% of the CEC of the clay. Other suitable values include about 50, 52, 54, 56, 58, 60, 62, 64, 66, 68, 70, 72, 74, 76, 78, 80, 82 84, 86, 88, 90, 92, 94, 96, 98, 100, 102, 104, 106, 108, 110, 112, 114, 116, 118, and 120% CEC. In embodiments in which the modified clay sorbent includes a first clay intercalated with a mono-quatemary compound and a second clay intercalated with one or more multifunctional-quatemary compounds having a functionality of 3 or more, the first and second clays can be intercalated to the same or different CEC.

In embodiments, the multifunctional-quaternary amine compound having a functionality of 3 or more can be a multifunctional-quaternary amine compound having at least 18 carbons. It is believed that multifunctional-quatemary amine compounds having a functionality of 3 or more with small head groups and hydrophobicity function well in combination with mono-quatemary amine compounds in the modified clay sorbents to significantly increase removal efficiency and capacity of the modified clay sorbents.

For example, the modified clay sorbent can include as the one or more of the multifunctional-quatemary amine compounds having a functionality of 3 or more, one or more of N-tallowalkyl dipropylene triamine (Triameen® T); N-tallowalkyl tripropylene tetramine (Tetrameen® T); acryloyloxylethyltrimethyl ammonium chloride; hexaethylguanidium chloride; 1H-Pyrido[3,4-b]indolium, 2,3,4,9-tetrahydro-1,2-dimethyl-2-[3-(trimethylammonio)propyl]-, bromide (1:2); 4-Aza-1-azoniabicyclo[2.2.2]octane, 1,1′-(1,10-decanediyl)bis-, bromide (1:2); Piperazinium, 1,1′-(1,6-hexanediyl)bis[4-(3-chloro-2-hydroxypropyl)-1-methyl-, dibromide, dihydrochloride (9Cl); 1,10-Decanediaminium, N1,N10-bis[4-(hydroxyimino)butyl]-N1,N1,N10,N10-tetramethyl-, bromide (1:2); 1,2-Ethanediaminium, N1,N2-bis[2-[bis(2-hydroxyethyl)methylammonio]ethyl]-N1,N2-bis(2-hydroxyethyl)-N1,N2-dimethyl-, chloride (1:4); Piperazinium, 1,1′-(1,10-decanediyl)bis[4-(3-chloro-2-hydroxypropyl)-1-methyl-, dibromide, dihydrochloride (9Cl); 1,6-Hexanediaminium, N1,N6-bis[2-[[bis(1-methylethoxy)phosphinyl]amino]ethyl]-N1,N1,N6,N6-tetramethyl-, bromide (1:2); 1,3-Propanediaminium, N-[2-[(12-hydroxy-1-oxo-9-octadecenyl)amino]ethyl]-N,N,N′,N′,N′-pentamethyl-, dichloride, [R-(E)]-(9Cl); 1,6-Hexanediaminium, N1,N1,N6,N6-tetramethyl-N1,N6-bis[6-(trimethylammonio)hexyl]-, bromide (1:4); 1,6-Hexanediaminium, N1,N1,N1,N6-tetramethyl-N6,N6-bis[6-(trimethylammonio)hexyl]-, iodide (1:4); Ammonium, octamethylenebis[dimethyl[2-(phosphonoamino)ethyl]-, dibromide, tetraisopropyl ester (8Cl); 5′-Thymidylic acid, 3′-[5-[diethyl[4-(triethylammonio)butyl]ammonio]pentanoate], bis(inner salt) (9Cl); Thymidine, 3′-[5-[diethyl[4-(triethylammonio)butyl]ammonio]pentanoate], dichloride (9Cl); 1,3-Propanediaminium, N1,N1,N3-tributyl-N3-[3-(dibutylmethylammonio)propyl]-N1,N3-dimethyl-; 1,3-Propanediaminium, N1,N1,N3-tributyl-N3-[3-(dibutylmethylammonio)propyl]-N1,N3-dimethyl-, iodide (1:3); 1,6-Hexanediaminium, N,N′-bis[3-(1,3-dihydro-1,3-dioxo-2H-isoindol-2-yl)propyl]-N,N,N′,N′-tetramethyl-(9Cl); Piperazinium, 1,1′-(1,6-hexanediyl)bis[1,4-dimethyl-4-(phenylmethyl)-, tetraiodide (9Cl); 1,3-Propanediaminium, N1,N3-diethyl-N1-[3-(ethyldimethylammonio)propyl]-N1-(2-hydroxyhexadecyl)-N3,N3-dimethyl-, ethyl sulfate (1:3); 1,3-Propanediaminium, N1-[3-[bis(2-hydroxyethyl)methylammonio]propyl]-N1-[3-(dodecyloxy)-2-hydroxypropyl]-N1,N3-bis(2-hydroxyethyl)-N1,N3-dimethyl-, methyl sulfate (1:3); 3-Aza-9-azoniabicyclo[3.3.1]nonane, 9,9′-trimethylenebis[3-benzyl-9-methyl-, diiodide (8Cl); 1,6-Hexanediaminium, N1,N6-bis[6-(diethylmethylammonio)hexyl]-N1,N6-diethyl-N1,N6-dimethyl-, iodide (1:4); 3-Aza-9-azoniabicyclo[3.3.1]nonane, 9,9′-(1,6-hexanediyl)bis[9-methyl-3-(phenylmethyl)-, diiodide (9Cl); 1,6-Hexanediaminium, N1,N1-bis[6-(dimethylpropylammonio)hexyl]-N6,N6-dimethyl-N1,N6-dipropyl-, iodide (1:4); 3-Aza-9-azoniabicyclo[3.3.1]nonane, 9,9′-(1,7-heptanediyl)bis[9-methyl-3-(phenylmethyl)-, diiodide (9Cl); 1,6-Hexanediaminium, N1,N6-bis[2-(9H-carbazol-9-yl)ethyl]-N1,N1,N6,N6-tetramethyl-, bromide (1:2); 10H-Phenothiazine-10-ethanaminium, N-[2-[diethyl[2-(10H-phenothiazin-10-yl)ethyl]ammonio]ethyl]-N,N-diethyl-; 1,6-Hexanediaminium, N1,N1,N6,N6-tetramethyl-N1,N6-bis[2-(10H-phenothiazin-10-yl)ethyl]-, bromide (1:2); 10H-Phenothiazine-10-ethanaminium, N-[2-[diethyl[2-(10H-phenothiazin-10-yl)ethyl]ammonio]ethyl]-N,N-diethyl-, bromide (1:2); 1,6-Hexanediaminium, N1,N1,N1,N6-tetraethyl-N6,N6-bis[6-(triethylammonio)hexyl]-, iodide (1:4); 1,6-Hexanediaminium, N,N′-bis[3-(1,3-dioxo-1H-benz[de]isoquinolin-2(3H)-yl)propyl]-N,N,N′,N′-tetramethyl-(9Cl); 1,6-Hexanediaminium, N1,N1,N6,N6-tetramethyl-N1,N6-bis[3-[dimethyl(4-phenylbutyl)ammonio]propyl]-; 1,8-Octanediaminium, N1,N1,N8,N8-tetraethyl-N1,N8-bis[6-(triethylammonio)hexyl]-, iodide (1:4); 1,6-Hexanediaminium, N1,N6-dimethyl-N1,N1-bis[6-(methyldipropylammonio)hexyl]-N6,N6-dipropyl-, iodide (1:4); Benzoxazolium, 2,2′-[1,3-propanediylbis[(dimethyliminio)-3,1-propanediyl-1(4H)-pyridinyl-4-ylidenemethylidyne]]bis[3-methyl-, iodide (1:4); Benzothiazolium, 2,2′-[1,3-propanediylbis[(dimethyliminio)-3,1-propanediyl-1(4H)-pyridinyl-4-ylidenemethylidyne]]bis[3-methyl-, iodide (1:4); 1,6-Hexanediaminium, N,N,N′,N′-tetraethyl-N,N′-bis[2-(10H-phenothiazin-10-yl)ethyl]-(9Cl); 1,6-Hexanediaminium, N1,N1,N6,N6-tetraethyl-N1,N6-bis[2-(10H-phenothiazin-10-yl)ethyl]-, bromide (1:2); 1,6-Hexanediaminium, N1,N6-bis[6-(diethylpropylammonio)hexyl]-N1,N6-diethyl-N1,N6-dipropyl-, iodide (1:4); 1,10-Decanediaminium, N1,N1,N10,N10-tetraethyl-N1,N10-bis[6-(triethylammonio)hexyl]-, iodide (1:4); 1,6-Hexanediaminium, N1,N6-bis[3-(3,4-dihydro-4-oxo-2-phenyl-1(2H)-quinazolinyl)propyl]-N1,N1,N6,N6-tetramethyl-, bromide (1:2); 1,8-Octanediaminium, N1,N1,N8,N8-tetraethyl-N1,N8-bis[8-(triethylammoni)octyl]-, iodide (1:4); Benzoxazolium, 2,2′-[1,3-propanediylbis[(dimethyliminio)-3,1-propanediyl-1(4H)-pyrdinyl-4-ylidene-1-propen-1-yl-3-ylidene]]bis[3-methyl-, iodide (1:4); Benzothiazolium, 2,2′-[1,3-propanediylbis[(dimethyliminio)-3,1-propanediyl-1(4H)-pyridinyl-4-ylidene-1-propen-1-yl-3-ylidene]]bis[3-methyl-, iodide (1:4); 1,10-Decanediaminium, N,N″-1,6-hexanediylbis[N,N,N′,N′,N′-pentaethyl-, tetraiodide (9Cl); 1,6-Hexanediaminium, N,N″-[(ethylsulfonio)di-6,1-hexanediyl]bis[N,N,N′,N′,N′-pentamethyl-, pentaiodide (9Cl); 1,10-Decanediaminium, N,N,N′,N′-tetraethyl-N,N′-bis[2-(10H-phenothiazin-10-yl)ethyl]-(9Cl); 10H-Phenothiazine-10-ethanaminium, N-[10-[diethyl[2-(10H-phenothiazin-10-yl)ethyl]ammonio]decyl]-N,N-diethyl-, bromide (1:2); Quinolinium, 1,1′-[1,3-propanediylbis[(dimethyliminio)-3,1-propanediyl]]bis[4-[(3-methyl-2(3H)-benzoxazolylidene)methyl]-, iodide (1:4); Quinolinium, 1,1′-[1,3-propanediylbis[(dimethyliminio)-3,1-propanediyl]]bis[4-[(3-methyl-2(3H)-benzothiazolylidene)methyl]-, iodide (1:4); Phenanthridinium, 3,8-diamino-5-[3-[[3-[dimethyl[3-[4-[(3-methyl-2(3H)-benzothiazolylidene)methyl]quinolinio]propyl]ammonio]propyl]dimethylammonio]propyl]-6-phenyl-, chloride (1:4); Benzothiazolium, 3,3′-[1,6-hexanediylbis[(dimethyliminio)-4,1-butanediyl]]bis[2-[2-[4-(dimethylamino)phenyl]ethenyl]-, iodide (1:4);Quinolinium, 1,1′-[1,3-propanediylbis[(dimethyliminio)-3,1-propanediyl]]bis[4-[3-(3-methyl-2(3H)-benzoxazolylidene)-1-propen-1-yl]-, iodide (1:4); Quinolinium, 1,1′-[1,3-propanediylbis[(dimethyliminio)-3,1-propanediyl]]bis[4-[3-(3-methyl-2(3H)-benzothiazolylidene)-1-propen-1-yl]-, iodide (1:4); 1,3-Propanediaminium, N1-[3-[[3-[bis(phenylmethyl)amino]propyl](phenylmethyl)amino]propyl]-N1,N3-dimethyl-N1,N3,N3-tris(phenylmethyl)-, methyl sulfate (1:2); 1,2-Ethanediaminium, N1-[2-[dimethyl[2-(octadecyloxy)-2-oxoethyl]ammonio]ethyl]-N1,N2,N2-trimethyl-N1,N2-bis[2-(octadecyloxy)-2-oxoethyl]-, chloride (1:3); Poly[(dimethyliminio)-2-butene-1,4-diyl chloride (1:1)], α-[4-[tris(2-hydroxyethyl)ammonio]-2-buten-1-yl]-ω-[tris(2-hydroxyethyl)ammonio]-, chloride (1:2).

For example, the modified clay sorbent can include as the one or more of the multifunctional-quatemary amine compounds associated as moieties off of a polymer backbone or incorporated into a polymer backbone. These multi-cation containing polymers can include Suitable cationic, polymeric flocculants/coagulants include polyquatemium-1 (CAS #: 68518-54-7); polyquatemium-2 (CAS #: 63451-27-1); polyquatemium-4 (copolymer of hydroxyethylcellulose and diallyldimethyl ammonium chloride); polyquatemium-5 (CAS #: 26006-22-4); polyquatemium-6 (polyallyldimethylammonium chloride; polydimethyldiallylammonium chloride; Magnafloc 370 (CAS #: 26062-79-3); polyquatemium-7 (CAS #: 26590-05-6); polyquatemium-8 (poly((methyl, stearyl) dimethylaminoethyl methacrylate), polyquatemium-9 (polydimethylaminoethylmethacrylate bromide); polyquatemium-10 (CAS #s: 53568-66-4, 55353-19-0, 54351-50-7, 81859-24-7; 68610-92-4, 81859-24-7); polyquatemium-11 (polyvinyl-N-ethyl-methylpyrrolidonium); poly(ethyldimethylammoniumethylmethacrylate) sulfate copolymer), polyquatemium-12 (CAS #: 68877-50-9); polyquatemium-13 (CAS #: 68877-47-4); polyquatemium-14 (CAS #: 27103-90-8); polyquatemium-15 (CAS #: 35429-19-7); polyquatemium-16 (quatemary ammonium salt of methyl-vinylimidazolium chloride and vinylpyrrolidone) (CAS #: 95144-24-4); polyquatemium-17 (adipic acid-dimethylaminopropylamine polymer (CAS #: 90624-75-2); polyquatemium-18 (azelaic acid, dimethylaminopropylamine, dicholorethylether polymer, CAS #: 113784-58-0); polyquatemium-19 (polyvinyl alcohol, 2,3-epoxypropylamine polymer (CAS #: 110736-85-1); polyquatemium-20 (polyvinyl octadecylether, 2,3-epoxypropylamine polymer (CAS #: 110736-86-2); polyquatemium-22 (CAS #: 53694-17-0); polyquatemium-24 (hydroxyethylcellulose, lauryl dimethylammonium epoxide polymer); polyquatemium-27 (copolymer of polyquatemium-2 and polyquatemium-17, CAS #: 131954-48-4); polyquatemium-28 (vinylpyrrolidone, dimethylaminopropylmethacrylamide copolymer, CAS #: 131954-48-8), polyquatemium-29 (chitosan, CAS #: 9012-76-4); propylene oxide polymer reacted with epichlorohydrin); polyquatemium-30 (methylmethacrylate, methyl(dimethylacetylammoniumethyl)acrylate copolymer, (CAS #: 147398-77-4); polyquatemium-33 (CAS #: 69418-26-4); poly(ethylene(dialkyl)ammonium) polymethacrylamidopropyltrimonium chloride (CAS #: 68039-13-4); and poly(2-acryloyloxyethyl)trimethylammonium).

In accordance with embodiments, the mono-quatemary amine compound can be a mono-quatemary amine compound having at least 8 carbons. For example, the mono-quatemary amine compound can be a long chain alkyl-ammonium compound with the alkyl radical having at least 8 carbons. In embodiments, the mono-quatemary amine can have at least 14 carbons. Any such known mono-quatemary compounds can be used. For example, suitable mono-quatemary amine compounds are disclosed in U.S. Patent Application Publication No. 2004/00185109, the relevant disclosure of which is incorporated herein by reference. For example, the mono-quatemary amine compound can be an ammonium cation that contains at least one linear or branched, saturated or unsaturated alkyl group having 12 to 22 carbon atoms. The remaining groups can be chosen from (a) linear or branched alkyl groups having 1 to 22 carbon atoms; (b) aralkyl groups which are benzyl and substitute benzyl moieties including fused ring moieties having linear or branched 1 to 22 carbon atoms in the alkyl portion of the structure; (c) aryl groups such as benzyl and substituted benzyl including fused ring aromatic substituents; (d) beta, gamma-unsaturated groups having size or less carbons or hydroalkyl groups having 2 to 6 carbon atoms; and (e) hydrogen.

Suitable mono-quaternary amines for intercalation in a clay are generally known in the art. The onium ions may generally be represented by the following formula:

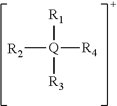

The preferred mono-quatemary amine compound agents for treating the clay can be one or more onium salt compounds, generally represented by the following formula:

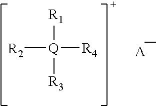

wherein Q=N, P, S;
wherein A=halide, acetate, methylsulfate, hydroxide, preferably chloride;
wherein R₁, R₂, R₃ and R₄ are independently organic moieties, or oligomeric moieties or hydrogen. U.S. Pat. No. 6,376,591 disclosed suitable compound, and the relevant disclosure is hereby incorporated by reference. Examples of useful organic moieties include, but not limited to, linear or branched alkyl, benzyl, aryl or aralkyl moieties having 1 to about 24 carbon atoms.

Suitable mon-quatemary amine compounds include, for example, bis(hydrogenated tallow alkyl)dimethyl ammonium chloride (Arquad® 2HT); benzylbis(hydrogenated tallow alkyl)methyl ammonium chloride (Arquad® M2HTB); di(ethyl tallowalkylate)dimethyl ammonium chloride (Arquad® DE-T); benzyl(hydrogenated tallow alkyl)dimethyl ammonium chloride (Arquad® DMHTB); trihexadecylmethyl ammonium chloride (Arquad® 316); tallowalkyl trimethyl ammonium chloride (Arquad® T-27W and ArquadO T-50); hexadecyl trimethyl ammonium chloride (ArquadO 16-29W and ArquadO 16-50); octadecyl trimethyl ammonium chloride (Arquad® 18-50(m)); and dimethylhydrogenated tallow-2-ethylhexyl ammonium methylsulfate; dimethyl di(C14-C18 alkyl) ammonium chloride (Adogen® 442 (EVONIK).

The onium ions may be functionalized such as protonated α,ε-amino acid with the general formula (H₃N—(CH₂)ₙ—COOH). Alkoxylated quaternary ammonium chloride compounds can include those disclosed in U.S. Pat. No. 5,366,647, the relevant disclosure of which is hereby incorporated by reference. Examples of suitable compounds can include cocoalkylmethylbis(2-hydroxyethyl) ammonium chloride (Ethoquad® C/12); octadecylmethyl[polyoxyethylene(15)] ammonium chloride (Ethoquad® 8/25); and octadecylmethyl (2-hydroxyethyl) ammonium chloride (Ethoquad 18/12).

The modified clay sorbents of the disclosure can further include one or more additives. Additives can include, for example, binders, dispersing aids, and functional additives. For example, the dispersing aid can be one or more of acrylic copolymers or biopolymers such as guar cum, xanthan cum, welan gum, cellulose, polysaccharides, starch, lactic acid, polyesters, citric acid/sodium bicarbonate, soy protein and combinations thereof. Binder can include any suitable binders, such as starch, superabsorbent polymers, and clay. Functional additives can include for example, one or more of activated carbon, anthracite, coke, organic-rich topsoil, organic-rich sediment, humus, apatite, zeolite, iron ore-rich material, organic shale, lime, gypsum, elemental sulfur, bauxite, fish meal, zero-valent iron and/or oxides or hydroxides of iron, manganese and/or aluminum and combinations thereof. Any other additives needed, for example, for a particular application or environment in which the modified clay sorbents are to be used can be included.

Methods of Sorbing PFAS with the Modified Clay Sorbents and Modified Clay Sorbent Blends

In use, the modified clay sorbents can be mixed with a PFAS contaminated source I to bind and immobilize the PFAS. For example, the modified clay sorbent can be mixed with PFAS contaminated soil. The modified clay sorbents can be mixed with cement admixtures into PFAS contaminated soils to bind and immobilize the PFAS. The modified clay sorbents can be added to vessels and PFAS contaminated water or other sources can be pumped through the vessels to interact with the modified clay sorbent and remove PFAS from the water. The modified clay sorbents can be used in a treatment vessel in line with activated carbon, ion exchange resins, and other PFAS removal media vessels. In embodiments, the modified clay sorbent can be used in “slurry wall” construction to prevent underground spread of PFAS in ground water. The modified clay sorbent can be suspended in water and injected into a contaminated groundwater plume. The modified clay sorbent can be included in a geotextile mat for placement in or onto a contaminated source, such as in the bottoms of rivers, lakes, and oceans to prevent the spread of PFAS compound into larger bodies of water.

In methods that include use of the modified clay sorbent having a blend of first and second modified clays, the blend can be provided as a single composition for single addition to the contaminated source. Alternatively, the first and second modified clays can be provided as separate components, for separate addition. In such embodiments, the first modified clay can be added simultaneously with the second modified clay. The first and second modified clays can be added sequentially in either order. The method can further include adding additional components, for example, a third modified clay. The third modified clay can be intercalated, for example, with a blend of mono-quatemary amine compound and multifunctional-quatemary amine compound having a functionality of 3 or more.

A kit for sorption of PFAS can include a first modified clay intercalated with a mono-quatemary amine compound and a second modified clay intercalated with a multifunctional-quatemary amine compound having a functionality of 3 or more. The kit can further include instructions for adding the first and second modified clays in a molar ratio of about 75:25 to about 5:95 or about 75:25 to about 50:50 mono-quaternary amine compound: multifunctional-quatemary amine compound having a functionality of 3 or more. In other words, the kit can include instructions for addition of the components of the modified clay sorbet such that a total amount of multifunctional-quaternary amine compound having a functionality of 3 or more added to the sample is about 25 mol % to about 95 mol % of the total moles of quaternary amine compounds added to the sample. For example the molar ratio of mono-quaternary amine compound: multifunctional-quatemary amine compound can be about 75:25 to about 50:50, about 80:20 to about 60:40, and about 75:25 to about 70:30, or about 40:60 to about 10:90. The molar ratio can include any of the foregoing described amounts of multifunctional-quatemary amine compound having a functionality of 3 or more for the modified clay sorbents and modified clay sorbent blends. The kit can further include instructions for simultaneous or sequential addition of the first and second modified clays.

In embodiments, a kit for sorption of PFAS can include a modified clay sorbent that includes a single blended material containing a first modified clay intercalated with a mono-quatemary amine compound and a second modified clay intercalated with a multifunctional-quatemary amine compound with a functionality of 3 or more. The kit can further include one or more additional modified clays, intercalated with one or more mono-quaternary amine compounds or one or more multifunctional-quatemary amine compounds having a functionality of 3 or more. The kit can further include instructions for adding the one or more additional modified clays to the contaminated source simultaneously or sequentially with the modified clay sorbent blend, thereby allowing the molar ratio of mono-quatemary amine compound to multifunctional-quatemary amine compound having a functionality of 3 or more to be modified on-site for a given contaminated source.

In any of the embodiments of methods of sorbing PFAS with the modified clay sorbent, the modified clay sorbent can be provided in a variety for forms. For example, the method can include flow-through vessels, reactive needle punched mats, rigid gabion, and batch processing. For example, the modified clay sorbents can be applied to a contaminated source as a reactive core mat, through in situ stabilization methods, through mixtures with cement and/or soil, and in pump and treat type applications. PFAS compounds can be sorbed at various stages of contamination. For example, modified clay sorbents can be applied at the source of the contamination, such as on the direct site of the application of a firefighting foam. Soil, groundwater, and surface water can also be contaminated by PFAS compounds and treatment can be at one or more of these sites. The methods of the disclosure can be tailored depending on the location and environment in which PFAS compound remediation is needed. For example, in embodiments, a dry granular mixture or reactive mat can be applied. In other embodiments, slurries and other wet applications can be used. Application methods can include solid mixing. This can include boring holes and/or trenches into the soil and dispensing the modified clay sorbets and mixing into the soil. Jet spraying applications can be used where slurries or other wet applications of the modified clay sorbents are useful.

For example, a contaminated waste water stream or other waste sample can be treated by passing the contaminated water through a bed of modified clay sorbent. In embodiments, the contact time of the contaminated water with the bed of modified clay sorbent is at least 1 minute.

A method of sorbing PFAS compounds from a contaminated waste water stream or other waste sample can include contacting the contaminated water stream with a modified clay sorbent in a prepacked preamble mat or gabion.

A method of sorbing PFAS compounds from a contaminated waste water stream or other waste sample can include delivering a modified clay sorbent in a granular or powder form into a body of water, such that the modified clay sorbent forms a permeable reactive barrier layer.

A method of sorbing PFAS compounds from a contaminated waste water stream or other waste sample can include treating the contaminated water in a reaction vessel by mixing a modified clay tank with the contaminated water in the reaction vessel.

A method of sorbing PFAS compounds from a contaminated waste water stream or other waste sample can include suspending the modified clay in water an injecting into a contaminated groundwater plume.

Modified clay sorbents can be made, for example, by mixing an aqueous solution of N-tallowalkyl dipropylene triamine (50 mole %) and dimethyl dehydrogenated tallow ammonium chloride (50 mole %) (Adogen 442) to a dispersion of bentonite in water. In an alternative example, an aqueous solution of polydiallyldimethylammonium chloride (50 mole % ammonium groups) and dimethyl dehydrogenated tallow ammonium chloride (50 mole %) (Adogen 442) to a dispersion of bentonite in water. The modified clay can be prepared as follows: A 1 liter metal cup is used to hold 700 ml of deionized water. The cup is placed on a hot plate equipped with an overhead stirrer. The water is heated to 70° C. and stirred at 200 RPM using a waring blade. The bentonite clay (Volcay API Gel NT) can be added slowly in small increments, allowing time for hydration, and stirred for 10 minutes. The mono-quaternary amine compound and tri-quatemary amine compound are weighed and added separately. The mono-quaternary amine compound can be added to the bentonite clay water mixture slowly and stirred for 10 minutes. The tri-quaternary amine compound can be added next, slowly, and mixed for 10 minutes. The sample can be stirred for two hours maintaining a temperature range of 70-75° C. The mixture can be vacuum filtered and the solids are collected on a Whatman #1 filter paper. The solids are then rinsed with 1000 ml of water. The solids are collected and rinsed in 800 mL of deionized water, heated to a temperature of 60-65° C. The sample is stirred at 200 RPM for 4 hours. The solids are then vacuum filtered a second time and rinsed with 2500 mL of deionized water. The solids are then transferred to a glass dish and dried for 16 hours at 50° C. The material can be then milled using a Retsch mill equipped with a 0.2 μm screen.

### Example

Modified clay sorbents having a clay functionalized with a mono-quaternary amine compound/tri-quatemary amine compound blend were prepared using a solution process. The amounts of mono-quatemary amine compound and tri-quaternary amine compound are shown in table 1 below. Treatment of the clay was performed such that the total quaternary charge represented 88% of the total cation exchange capacity of the clay. Various ratios of mono-quatemary amine compound to tri-quaternary amine compound were analyzed, ranging from 5 mol % tri-quatemary amine compound to 95 mol % tri-quatemary amine compound. Samples having 100% mono-quatemary amine and 100% tri-quatemary amine were included for comparative example.

Tallow dipropylene triamine was purchased from Nouryon under the tradename Triameen T. The protonated form of the tallow dipropylene triamine was produced in a 500 mL three neck round bottom flask by mixing 58 grams of Triameen T with 23.7 grams of ethanol and 245.4 grams of water. The mixture was allowed to stir overnight using a stainless-steel overhead mixing shaft. The mixture was cooled to 0° C. using an ice bath. Using a pipette, 49.16 grams of 35% hydrochloric acid was added to the mixture in a dropwise fashion. The temperature of the mixture was monitored and kept below 25° C. during the hydrochloric acid addition. The mixture was allowed to stir at room temperature for two hours.

The modified clay was prepared using a 1 liter metal cup filled with 700 ml of deionized water. The water was heated to 70° C. while stirring at 200 RPM using a waring blade of the hot plate equipped with an overhead stirrer. The bentonite clay (Volcay API Gel NT) was added solely in small increments, allowing time for hydration, and stirred for 10 minutes. The mono-quatemary amine compound and tri-quatemary amine compound were weighed and added separately. Adogen® 442 (EVONIK), a solution of dimethyl di(C14-C18 alkyl) ammonium chloride (86% by weight) was used as the mono-quaternary amine compound. The protonated tallow dipropylene triamine was used as the tri-quaternary amine compound. The mono-quatemary amine compound was added to the bentonite clay water mixture slowly and stirred for 10 minutes. The tri-quatemary amine compound was added next, slowly, and mixed for 10 minutes. The sample was then stirred for two hours maintaining a temperature range of 70-75° C. The mixture was vacuum filtered and the solids were collected on a #1 filter paper. The solids were then rinsed with 1000 ml of water. The solids were then collected and rinsed in 800 ml of deionized water, heated to a temperature of 60-65° C. The sample was stirred at 200 RPM for 4 hours and then vacuum filtered a second time and rinsed with 2500 mL of deionized water. The solids were then transferred to a glass dish and dried for 16 hours at 50° C. The material was milled using a Retsch mill equipped with a 0.2 μm screen.

TABLE 1
Modified Clay Formulations

| | | | | | Mass | Mass | |
|---|---|---|---|---|---|---|---|
| | % Mole | % Mole | Percent | Mass | of NT | Adogen | Mass |
| | Adogen | Triamine | of Clay | Water | Clay | 442 | Triameen |
| | 442 | T | CEC | (grams) | (grams) | Soln. | T Soln. |
| T-1 | 100 | 0 | 88 | 700.0 | 42.0 | 16.28 | 0.00 |
| T-2 | 95 | 5 | 88 | 700.0 | 42.0 | 15.47 | 2.96 |
| T-3 | 75 | 25 | 88 | 700.0 | 42.0 | 12.21 | 14.82 |
| T-4 | 50 | 50 | 88 | 700.0 | 42.0 | 8.14 | 29.63 |
| T-5 | 25 | 75 | 88 | 700.0 | 42.0 | 4.07 | 44.45 |
| T-6 | 5 | 95 | 88 | 700.0 | 42.0 | 0.81 | 56.30 |
| T-7 | 0 | 100 | 88 | 700.0 | 42.0 | 0.00 | 59.26 |

PFAS adsorption testing was performed by adding 3 mg of modified clay sorbent blend to a 500 ml water sample in a screw cap Nalgene® HDPE bottle. The bottle was placed on an orbital shaker at 10 RMP and mixed for 168 hours to approximate the adsorption equilibrium. Synthetic PFAS water was used in this testing to simulate contaminated water. The synthetic PFAS water (SPW) was prepared by dissolving perfluorobutanoic acid (PFBA), perfluorohexanoic acid (PFHxA), perfluorooctanoic acid (PFOA), perfluorobutanesulfonic acid (PFBS), perfluorohexanesulfonic acid (PHxS), perfluorooctane sulfonic acid (PFOS) in deionized water. The compounds were purchased from Wellington Laboratory in flame sealed glass ampoules. The SPW was prepared in a clean 5 gallon polypropylene pail equipped with a sealed lid. The PFAS compounds were obtained as 50 μg/ml solutions in ethanol. The ampoules were opened and individual solutions transferred into the DI water using a glass transfer pipet. The water used was carefully weighted in 1000 gram increments totaling 15000 grams. The concentrations of the individual compounds of the SPW are shown below, expressed as parts per billion (PPB) or μg/L. The “short chain” PFAS compounds in the SPW were PFBS, PFBA, and PFHxA molecules. The “long chain compounds” were PFHxS, PFOS, and PFOA molecules.

TABLE 2
Synthetic PFAS Water (SPW) Composition

| | Avg. Concentration | Amount |
|---|---|---|
| Analyte | (μg/l) | (ppb) |
| Perfluorobutanoic acid (PFBA) | 19.6 | 20.76 |
| Perfluorohexanoic acid (PFHxA) | 22.6 | 22.41 |
| Perfluorooctanoic acid (PFOA) | 20.6 | 19.30 |
| Perfluorobutanesulfonic acid (PFBS) | 28.6 | 27.18 |
| Perfluorohexane sulfonic acid (PFHxS) | 28.2 | 28.48 |
| Perfluorooctane sulfonic acid (PFOS) | 16.2 | 16.49 |
| Total | | 134.61 |

TABLE 3
Sample Composition and Results

| | Mono- | Tri- | PFAS Concentrations After Treatment | | | | | | |
|---|---|---|---|---|---|---|---|---|---|
| Sample | Quat | Quat | with Modified Clay Sorbent (ppb) | | | | | | |
| No. | mol % | mol % | PFBA | PFBS | PFHxA | PFHxS | PFOA | PFOS | TOTAL |
| T-1 | 100 | 0 | 19.36 | 14.37 | 19.69 | 2.49 | 5.80 | 0.93 | 62.65 |
| T-2 | 95 | 5 | 19.93 | 15.63 | 23.19 | 3.83 | 7.16 | 1.86 | 71.60 |
| T-3 | 75 | 25 | 19.81 | 9.35 | 15.44 | 6.06 | 4.76 | 4.42 | 59.84 |
| T-4 | 50 | 50 | 19.87 | 10.34 | 15.16 | 4.98 | 3.86 | 2.30 | 56.52 |
| T-5 | 25 | 75 | 20.36 | 11.99 | 14.40 | 2.14 | 1.08 | 1.03 | 51.01 |
| T-6 | 5 | 95 | 20.44 | 19.36 | 16.17 | 2.31 | 1.08 | 0.63 | 59.99 |
| T-7 | 0 | 100 | 20.16 | 21.98 | 17.65 | 3.49 | 1.37 | 0.14 | 64.80 |

TABLE 4
Percent PFAS Removal Results

| | Mono- | | | | | | | |
|---|---|---|---|---|---|---|---|---|
| | Quat | Tri-quat | PFAS Removal Percentage (%) | | | | | |
| Sample No. | mol % | mol % | PFBA | PFHxA | PFOA | PFBS | PFHxS | PFOS |
| T-1 | 100 | 0 | 7 | 12 | 70 | 47 | 91 | 94 |
| T-2 | 95 | 5 | 4 | -3 | 63 | 43 | 87 | 89 |
| T-3 | 75 | 25 | 5 | 31 | 75 | 66 | 79 | 73 |
| T-4 | 50 | 50 | 4 | 32 | 80 | 62 | 82 | 86 |
| T-5 | 25 | 75 | 2 | 36 | 94 | 56 | 92 | 94 |
| T-6 | 5 | 95 | 2 | 28 | 94 | 29 | 92 | 96 |
| T-7 | 0 | 100 | 3 | 21 | 93 | 19 | 88 | 99 |

| | Mono- | | PFAS Removal Percentage (%) | | | | |
|---|---|---|---|---|---|---|---|
| | Quat | Tri-quat | Short | Long | | | |
| Sample No. | mol % | mol % | Chain | Chain | Carboxylate | Sulfonate | Total |
| T-1 | 100 | 0 | 24 | 86 | 28 | 75 | 53 |
| T-2 | 95 | 5 | 16 | 80 | 20 | 70 | 47 |
| T-3 | 75 | 25 | 37 | 76 | 36 | 73 | 56 |
| T-4 | 50 | 50 | 36 | 86 | 38 | 76 | 58 |
| T-5 | 25 | 75 | 34 | 93 | 43 | 79 | 62 |
| T-6 | 5 | 95 | 20 | 94 | 40 | 69 | 55 |
| T-7 | 0 | 100 | 15 | 92 | 37 | 64 | 52 |

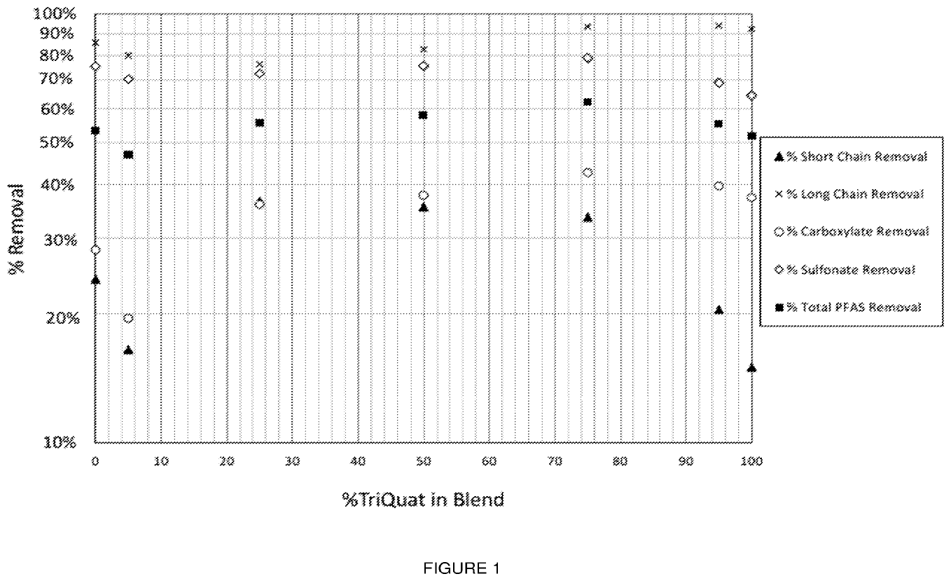

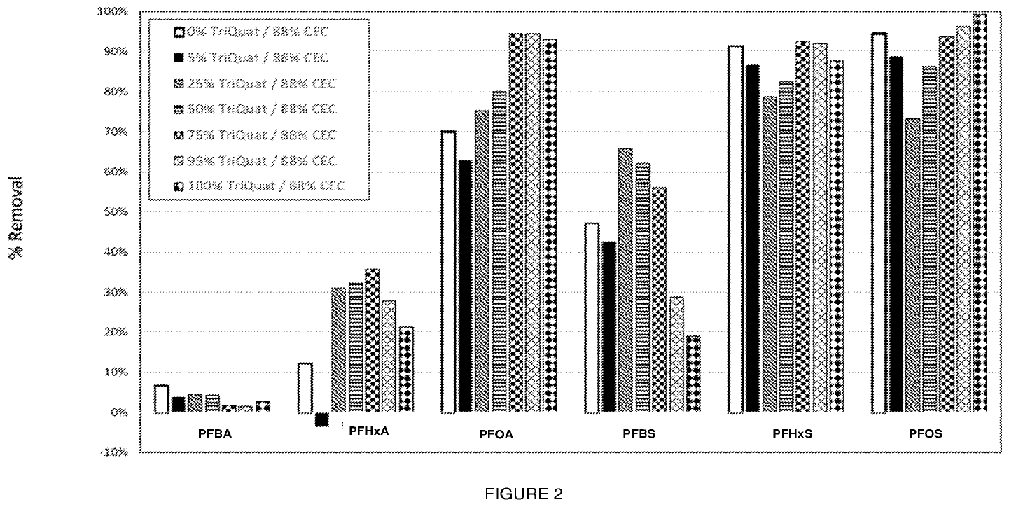

FIGS. 1 and 2 are graphs showing the percent removal of the various PFAS compound. It was found that inclusion of the greater than 20 mol % of the tri-quatermary amine compound significantly increase the removal of carboxylate-PFAS contaminates. Short chain removal was found to demonstrate improvement when the tri-quatermary amine compound was in the range of 20 to 80 mol %. For long chain removal, amounts in excess of 60 mol % were found to improve the removal as compared to 100 mol % mono-quatermary containing sorbents.

While particular embodiments of the present invention have been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustration only and not as limitations. The actual scope of the invention is to be defined by the subsequent claims when viewed in their proper perspective based on the prior art.

1. A modified clay sorbent for sorbing PFAS compounds from a contaminated sample, comprising:
a clay intercalated with one or more multifunctional-quaternary amine compounds having a functionality of 3 or more and one or more mono-quatemary amine compounds.

2. The modified clay sorbent of claim 1, wherein the clay is intercalated with the one or more multifunctional-quaternary amine compounds and one or more mono-quatemary amine compounds to at least 50% of the a total cationic exchange capacity of the clay.

3. A modified clay sorbent for sorbing PFAS compounds from a contaminated sample, comprising:
a first modified clay comprising a clay intercalated with the one or more mono-quatemary amine compounds; and
a second modified clay comprising a clay intercalated with the one or more multifunctional-quatemary amine compounds having a functionality of 3 or more.

4. (canceled)

5. The modified clay sorbent of claim 1, wherein the one or more multifunctional-quatemary amine compounds are present in a mole percent of about 20 mol % to about 80 mol % based on the total moles of quatemary amine compound present in the modified clay sorbent.

6. (canceled)

7. The modified clay sorbent of claim 3, wherein the first modified clay and the second modified clay are each intercalated with the respective one or more mono-quatemary amine compounds and multifunctional-quatemary amine compounds to at least about 50% of the cationic exchange capacity of the respective first or second modified clay.

8. The modified clay sorbent of claim 1, wherein the one or more multifunctional-quaternary amine compounds have 18 or more carbons.

9. The modified clay sorbent of claim 1, wherein the clay is one or more of attapulgite, bentonite, montmorllonite, nontronite, beidellite, volkonskoite, hectorite, sapponite, sauconite, sobockite, stevensite, svinfordite, vermiculite, palygorskite, kalonite, and sepiolite.

10. The modified clay sorbent of claim 1, wherein the modified clay sorbent is present in a mat.

11. The modified clay sorbent of claim 1, wherein the mono-functional quatemary amine is one or more of dimethyl di(C14-C18 alkyl) ammonium chloride.

12. A kit comprising: the modified clay sorbent of claim 1 and instructions for adding the clay sorbent to a contaminated sample for sorption of PFAS compounds.

13. A kit comprising:
the modified clay sorbent of claim 3, wherein the first and second modified clays are present as separate components, and
instructions for adding the first modified clay and the second modified clay individually to a contaminated sample to form the modified clay sorbent in amounts such that the one or more multifunctional-quaternary amine compounds are present in an amount of 20 mol % to about 80 mol % based on the total moles of quaternary amine compounds added to the sample.

14. (canceled)

15. (canceled)

16. (canceled)

17. A method of sorbing PFAS compounds from a contaminated sample, comprising:
admixing a modified clay sorbent with the sample, wherein the modified clay sorbent comprises a clay intercalated with a one or more mono-quaternary amine compounds and one or more multifunctional-quatemary amine compounds having a functionality of 3 or more; or
admixing a clay, one or more mono-quatemary amine compounds, and one or more multifunctional-quatemary amine compounds with the sample, wherein the clay is intercalated with the one or more mono-quatemary amine compounds and the one or more multifunctional-quatemary amine compounds in situ to form a modified clay sorbent for sorbing PFAS compounds from the contaminated sample.

18. (canceled)

19. The method of claim 17, wherein the one or more multifunctional-quatemary amine compounds are present in an amount of at least about 20 mol % based on the total moles of the quatemary amine compounds in the modified clay sorbent.

20. (canceled)

21. A method of sorbing PFAS compounds from a contaminated sample, comprising:
admixing a modified clay sorbent with the sample, wherein the modified clay sorbent comprises a first modified clay comprising a clay intercalated with a one or more mono-quatemary amine compounds and a second modified clay comprising a clay intercalated with one or more multifunctional-quatemary amine compounds having a functionality of 3 or more.

22. The method of claim 21, wherein a ratio of an amount of the first modified clay to the amount of the second modified clay is selected such that the one or more multifunctional-quaternary amine compounds are present in an amount of about 20 mol % to about 80 mol % based on the total moles of the quaternary amine compounds admixed with the sample.

23. (canceled)

24. (canceled)

25. (canceled)

26. (canceled)

27. (canceled)

28. The method of claim 17, wherein the one or more multifunctional-quaternary amine compounds comprises at least 18 carbons.

29. (canceled)

30. The method of claim 17, wherein the clay is one or more of attapulgite, bentonite, montmorillonite, nontronite, beidellite, volkonskoite, hectorite, sapponite, sauconite, sobockite, stevensite, svinfordite, vermiculite, palygorskite, kalonite, and sepiolite.

31. The method of claim 17, where the sorbent is capable of adsorbing at least 0.2 milligrams of PFAS compounds per gram of modified clay sorbent.

32. The method of claim 17, wherein the sample is a contaminated soil, and the method comprises mixing the contaminated soil and the modified clay sorbent such that the modified clay sorbent is present in an amount of greater than about 0.5 wt % of the modified clay sorbent in the mixture.

33. The method of claim 17, wherein the sample is a contaminated waste water stream, and the method comprises admixing the modified clay sorbent and the contaminated water stream by passing the contaminated water through a bed of the modified clay sorbent at a flow rate to maintain a contact time of the contaminated water with the bed of at least about 1 minute.

34. The method of claim 17, wherein the modified clay sorbent is in the form of a prepacked permeable mat or gabion.

35. The method of claim 17, wherein the modified clay sorbent in a granular or powder form into a body of water such that the modified clay forms a permeable reactive barrier layer.

36. The method of claim 17, comprising the treatment of PFAS compounds from a contaminated water stream by mixing the modified clay and contaminated water in a tank.

37. The method of claim 17, comprising the treatment of PFAS compounds from a contaminated water stream by injecting a suspension of the modified clay into contaminated soil and or a contaminated groundwater plume.

38. (canceled)

39. (canceled)

40.-82. (canceled)
